(19) United States
(12) Patent Application Publication
(10) Pub. No.: US 2017/0113713 A1
(43) Pub. Date: Apr. 27, 2017

(54) UNIT FOR VEHICLE STEERING SYSTEM

(71) Applicant: NTN CORPORATION, Osaka (JP)

(72) Inventors: Naotsugu KITAYAMA, Shizuoka (JP); Marina FUKUNARI, Osaka (JP); Koji SATO, Shizuoka (JP); Takahide SAITO, Shizuoka (JP)

(21) Appl. No.: 15/129,557

(22) PCT Filed: Mar. 26, 2015
(86) PCT No.: PCT/JP2015/059452

§ 371 Date: Sep. 27, 2016

(30) Foreign Application Priority Data
Mar. 28, 2014 (JP) 2014-068407

(51) Int. Cl. B62D 5/00; B62D 5/04; B62D 1/20

(52) U.S. Cl. CPC B62D 5/001; B62D 1/20; B62D 5/0403; B62D 3/12

(57) ABSTRACT

A unit for a vehicle steering system including a clutch mounted between the steering wheel and the pinion of the rack and pinion includes either a first shaft coupled to the steering wheel, or a second shaft coupled to the pinion, and the clutch, which is mounted in the rotation transmission path between the first shaft and the second shaft. The clutch includes an input shaft and an output shaft, one of which is fixed to, while being coaxial with, the first shaft or the second shaft.

### TECHNICAL FIELD

This invention relates to a unit for a vehicle steering system through which rotation is transmitted from a steering wheel to a rack and pinion.

### BACKGROUND ART

Steer-by-wire type steering systems are increasingly used in motor vehicles these days. In a typical steer-by-wire type steering system, the steering wheel of the vehicle is not mechanically coupled to the pinion of the rack and pinion through a clutch. Instead, the steering angle of the steering wheel is converted to an electrical signal based on which a controller drives a steering actuator, thereby controlling the steered angles of the steered vehicle wheels. The controller also controls a reaction force motor to apply a suitable steering reaction force to the steering wheel. If abnormality occurs in the steering actuator or the reaction force motor, the steering wheel is coupled to the pinion through the clutch so that the vehicle wheels are directly steered by the steering wheel. (See, for example, the below-identified Patent documents 1 and 2).

Electromagnetically switchable roller clutches are suitable as clutches for use in steer-by-wire type steering systems (such a roller clutch is disclosed in the below-identified Patent document 3).

### PRIOR ART DOCUMENTS

### Patent Documents

Patent document 1: JP Patent Publication 2005-262969A

Patent document 2: JP Patent 3180505

Patent document 3: JP Patent 4252392

### SUMMARY OF THE INVENTION

### Object of the Invention

As shown in FIG. 8, such a conventional steer-by-wire type steering system includes a rotation transmission path which is to be used during an abnormal situation, and which is made up of a first shaft 101 coupled to the steering wheel 100 of the vehicle, a second shaft 103 coupled to the pinion 102 of the rack and pinion, a clutch 104, a universal joint 107 coupling together the first shaft 101 and the input shaft 105 of the clutch 104, and a universal joint 108 coupling together the second shaft 103 and the output shaft 106 of the clutch 104. When rotation is transmitted with the first shaft 101 and the input shaft 105 forming an operating angle relative to each other, and with the second shaft 103 and the output shaft 106 forming an operating angle relative to each other, radial loads are produced, and applied to the input shaft 105 and the output shaft 106 via an intermediate shaft 109 of the universal joint 107 and an intermediate shaft 110 of the universal joint 108, respectively. This makes difficult the centering of the input shaft 105 and the output shaft 106, which is important in operating the clutch 104 in a stable manner.

In view of these circumstances, an object of the present invention is to provide a vehicle steering system of which the clutch mounted between the steering wheel and the pinion can be operated in a stable manner.

### Means for Achieving the Object

In order to achieve this object, the present invention provides a unit for a vehicle steering system comprising either a first shaft coupled to a steering wheel or a second shaft coupled to a pinion of a rack and pinion; and a clutch mounted in a rotation transmission path between the first shaft and the second shaft, wherein the clutch includes an input shaft and an output shaft, and either the input shaft is fixed to the first shaft while being coaxial with the first shaft, or the output shaft is fixed to the second shaft while being coaxial with the second shaft.

### Advantages of the Invention

With this arrangement, since either the input shaft of the clutch is fixed to the first shaft while being coaxial with the first shaft, or the output shaft of the clutch is fixed to the second shaft while being coaxial with the second shaft, it is necessary to use only one universal joint either on the side of the output shaft or on the side of the input shaft. This results in radial loads not being generated on one of the output shaft and the input shaft, which in turn makes it possible to operate the clutch in a more stable manner.

### BRIEF DESCRIPTION OF THE DRAWINGS

FIG. 1 schematically shows a unit for a vehicle steering system according to a first embodiment of the present invention.

FIG. 2 is a partial sectional view around a clutch and a pinion of the first embodiment.

FIG. 3 schematically shows a unit for a vehicle steering system according to a second embodiment of the present invention.

FIG. 4 schematically shows a unit for a vehicle steering system according to a third embodiment of the present invention.

FIG. 5 schematically shows a unit for a vehicle steering system according to a fourth embodiment of the present invention.

FIG. 6 schematically shows a unit for a vehicle steering system according to a fifth embodiment of the present invention.

FIG. 7 schematically shows a unit for a vehicle steering system according to a sixth embodiment of the present invention.

FIG. 8 schematically shows a conventional arrangement.

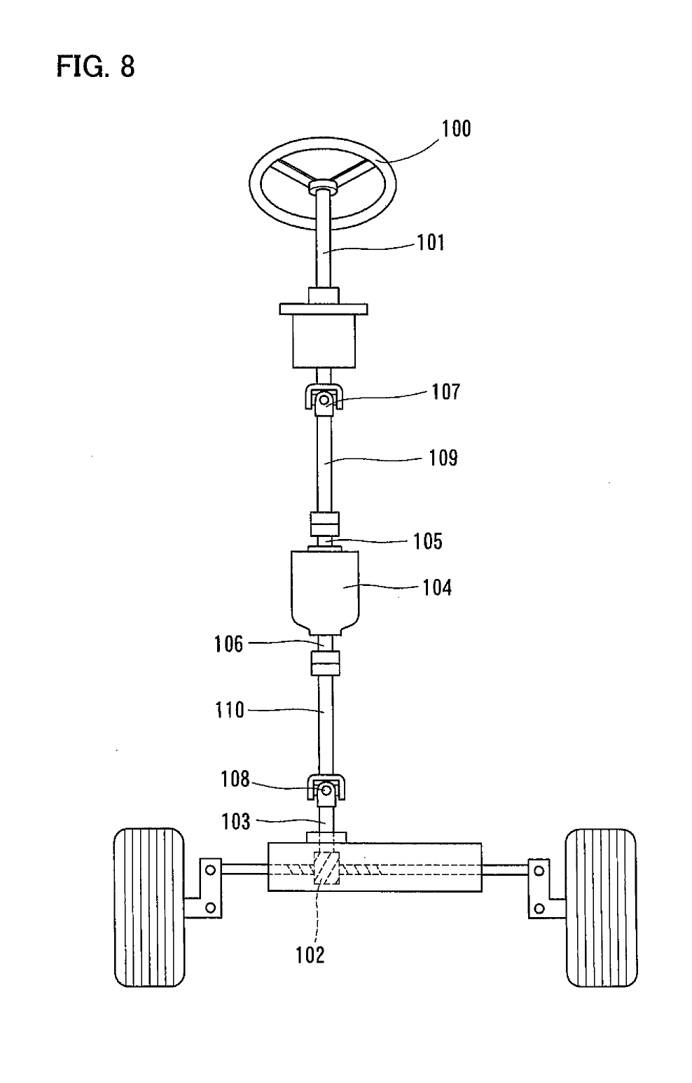

### BEST MODE FOR EMBODYING THE INVENTION

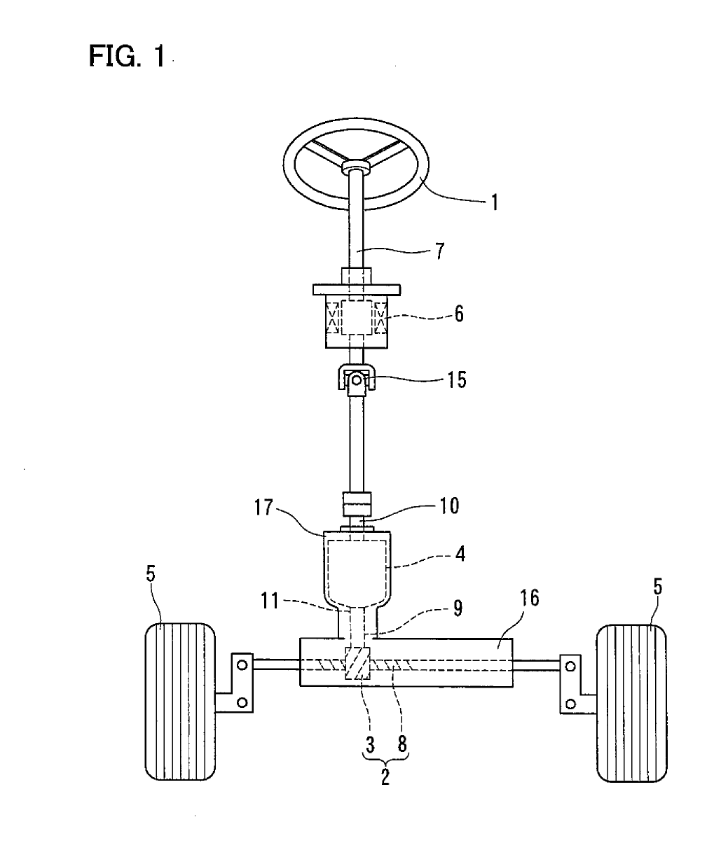

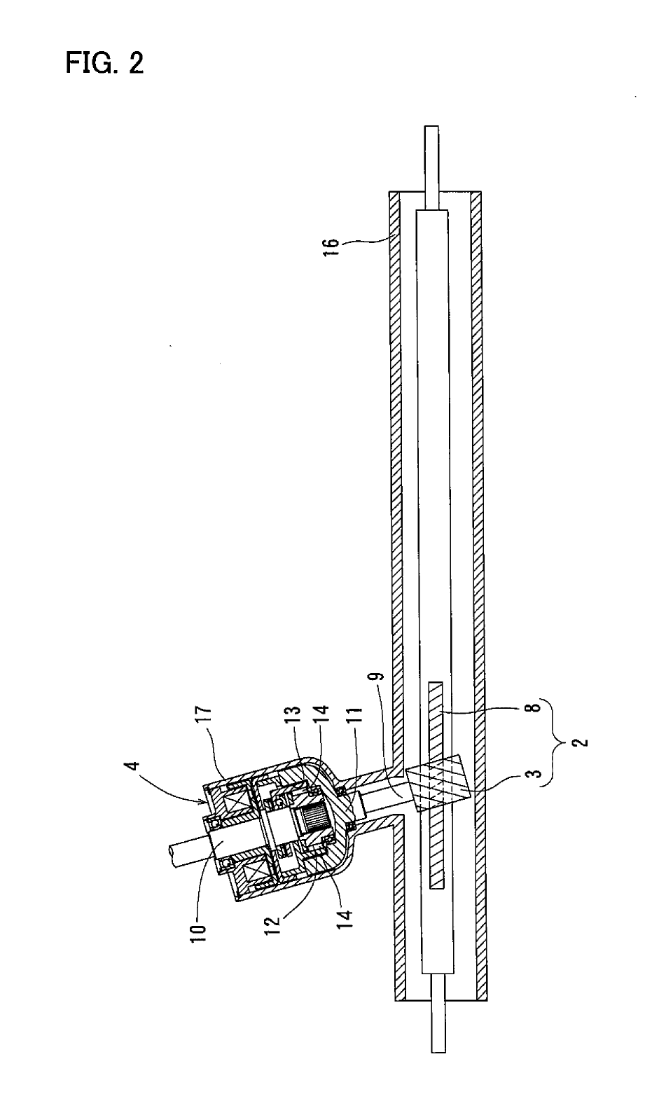

A unit for a vehicle steering system according to the first embodiment of the present invention is now described with reference to FIGS. 1 and 2. The vehicle steering system shown is a steer-by-wire type steering system, in which the steering wheel 1 of the vehicle is not mechanically coupled to the pinion 3 of the rack and pinion 2 through a clutch 4. Instead, the steering angle of the steering wheel 1 is converted to an electrical signal based on which the steered angles of the steered wheels 5 are automatically controlled by an electric steering actuator (not shown). Also, based on the electrical signal, a reaction force motor 6 is automatically controlled to apply a suitable steering reaction force to the steering wheel 1. If abnormality occurs in the electric steering actuator or the reaction force motor 6, the steering wheel 1 and the pinion 3 are coupled together through the clutch 4 so that the wheels 5 can be directly steered by the steering wheel 1.

A first shaft 7 is coupled to the steering wheel 1. The reaction force motor 6 applies a steering reaction force to the first shaft 7. The first shaft 7 is integral with the output shaft of the reaction force motor 6, so that the reaction force motor 6 is capable of directly applying the steering reaction force to the first shaft 7. The reaction force motor 6 has a housing mounted to a partition wall between the engine room and the passenger compartment of the vehicle.

The rack and pinion 2 comprises a rack 8, and the pinion 3, which meshes with the rack 8. A second shaft 9 is coupled to the pinion 3. The rack 8 is configured to be driven by the electric steering actuator.

The clutch 4 comprises a mechanical clutch portion, and a clutch switching means for selectively coupling and uncoupling the mechanical clutch portion. The clutch 4 includes an input shaft 10, an output shaft 11, an engaging surface 12 configured to rotate in unison with the input shaft 10, an engaging surface 13 configured to rotate in unison with the output shaft 11, and engaging elements 14 received in wedge-shaped spaces defined between the engaging surfaces 12 and 13. The clutch switching means is controlled by a controller (not shown) of the vehicle steering system. When the engaging elements 14 are brought into engagement with the engaging surfaces 12 and 13 by the clutch switching means, the clutch 4 is coupled, and when the engaging elements 14 are disengaged from the engaging surfaces 12 and 13, the clutch 4 is uncoupled. The clutch 4 may comprise the clutch disclosed in Patent document 1 or Patent document 3.

Torque is always applied from the steering wheel 1 to the input shaft 10 of the clutch 4. While the clutch 4 is coupled, torque from the steering wheel 1 is transmitted to the pinion 3 through the output shaft 11 of the clutch 4.

The input shaft 10 of the clutch 4 and the first shaft 7 are coupled together by a universal joint 15. As the universal joint 15, a constant velocity joint will be sufficient which is capable of transmitting rotation from the first shaft 7 to the input shaft 10 with the shafts 7 and 10 forming a required predetermined operating angle relative to each other. For example, the universal joint 15 may be a double cardan joint.

The output shaft 11 of the clutch 4 is integral with the second shaft 9. The word “integral” here means that the output shaft 11 and the second shaft 9 are formed into a single piece.

The rack and pinion 2 has a housing 16 which is integral with the housing 17 of the clutch 4. The word “integral” here means that the space surrounding the rack and pinion 2, the space surrounding the clutch 4, and the hole through which the output shaft 11 and the second shaft 9 extend forms a single, continuous space. The output shaft 11 is supported by the inner periphery of the housing 17 through a bearing.

In this first embodiment, since the output shaft 11 of the clutch 4 is integral with the second shaft 9, the output shaft 11 and the second shaft 9 are fixed to each other so as to be coaxial with each other, at all times. Thus, the rotation transmission path between the steering wheel 1 and the pinion 3 has no universal joint for coupling together the output shaft 11 and the second shaft 9, and has only the universal joint 15 on the side of the input shaft 10. Thus, with this arrangement, no radial load is applied to the output shaft 11 of the clutch 4, so that the clutch 4 operates more stably. Since there is no universal joint on the side of the output shaft 11, it is also possible to reduce the axial distance between the rack and pinion 2 and the clutch 4, so that the above-mentioned housings can be more easily made integral with each other.

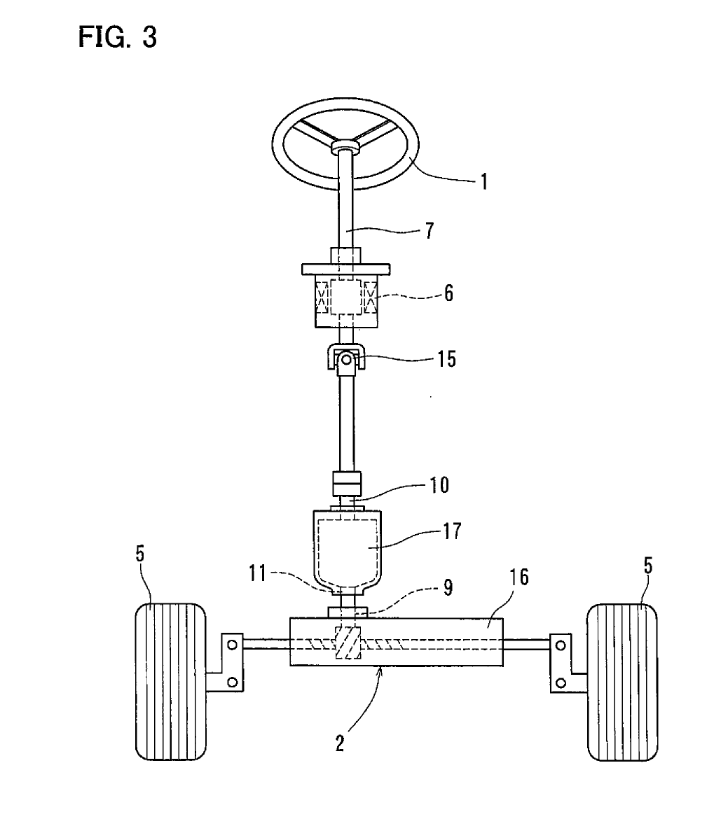

The second embodiment is described with reference to FIG. 3. Here, only what differs from the first embodiment is described. As shown, in the second embodiment, the housing 16 of the rack and pinion 2 and the housing 17 of the clutch 4 are separate members from each other. Even though the housings 16 and 17 are separate members, since the output shaft 11 and the second shaft 9 are integral with each other, the input shaft 10 and the second shaft 9 remain fixed to each other while being coaxial with each other. The housing 17 of the clutch 4 is mounted to the partition wall between the engine room and the passenger compartment of the vehicle.

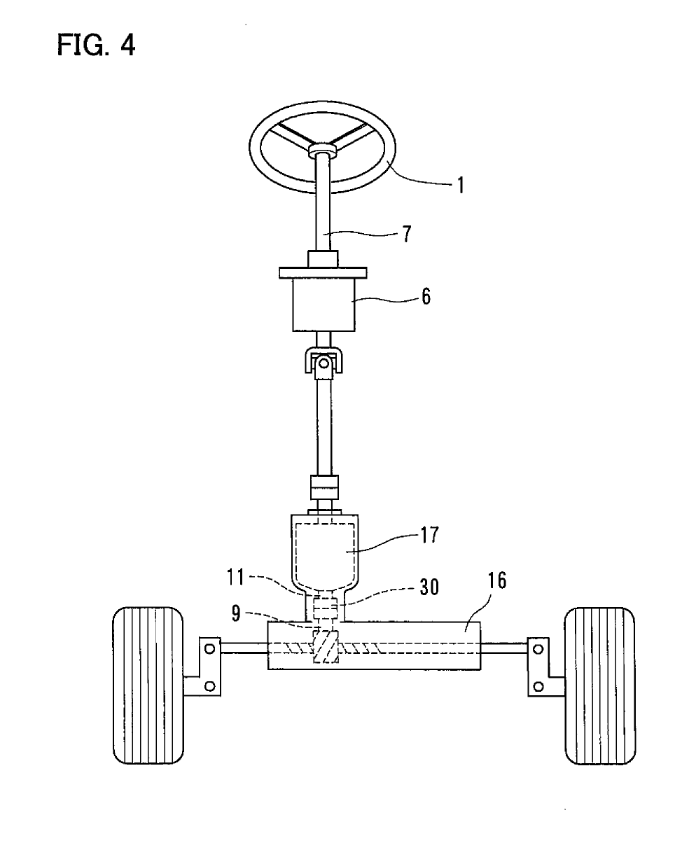

The third embodiment is described with reference to FIG. 4. As shown, in this embodiment, the output shaft 11 of the clutch 4 and the second shaft 9 are fixed to each other while being coaxial with each other, by a coupling means 30. The coupling means 30 are not limited provided the coupling means 30 is capable of transmitting rotation with the output shaft 11 and the second shaft 9 fixed to each other while being coaxial with each other. For example, the coupling means 30 may be serrations, splines and flanges.

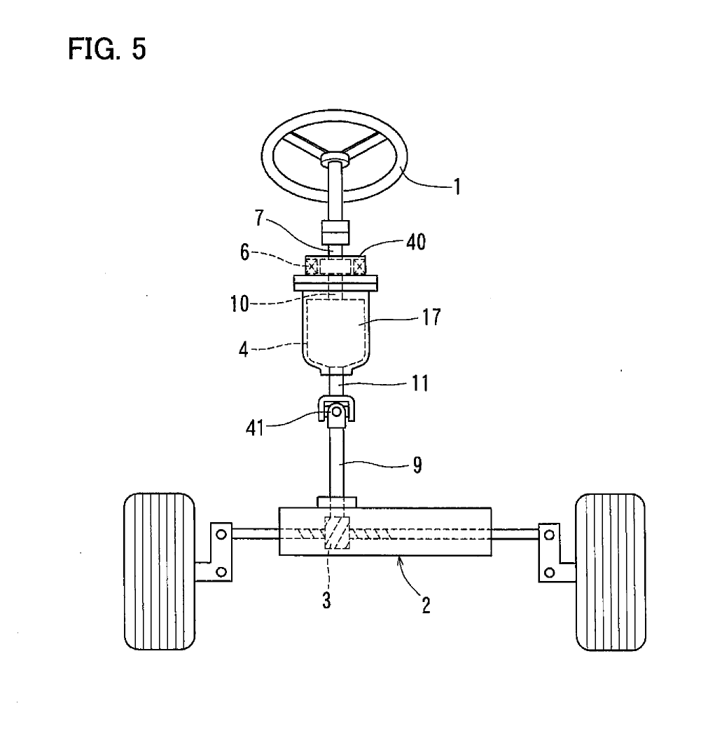

The fourth embodiment is described with reference to FIG. 5. As shown, in this embodiment, the housing 40 of the reaction force motor 6 and the housing 17 of the clutch 4 are integral with each other.

The output shaft 11 of the clutch 4 and the second shaft 9 are coupled to each other by a universal joint 41. The universal joint 41 is a constant-velocity joint capable of transmitting rotation from the output shaft 11 to the second shaft 9 with the output shaft 11 and the second shaft 9 forming a required operating angle relative to each other.

The input shaft 10 of the clutch 4 and the first shaft 7 are integral with each other.

With this arrangement, since the input shaft 10 of the clutch 4 and the first shaft 7 are integral with each other, the input shaft 10 and the first shaft 7 remain fixed to each other while being coaxial with each other, at all times. Thus, the rotation transmission path between the steering wheel 1 and the pinion 3 has no universal joint for coupling together the input shaft 10 and the first shaft 7, and has only the universal joint 41 on the side of the output shaft 11. Thus, with this arrangement, no radial load is applied to the input shaft 10 of the clutch 4, so that the clutch 4 operates more stably. Since there is no universal joint on the side of the input shaft 10, it is also possible to reduce the axial distance between the steering wheel 1 and the clutch 4, so that the above-mentioned housings can be more easily made integral with each other.

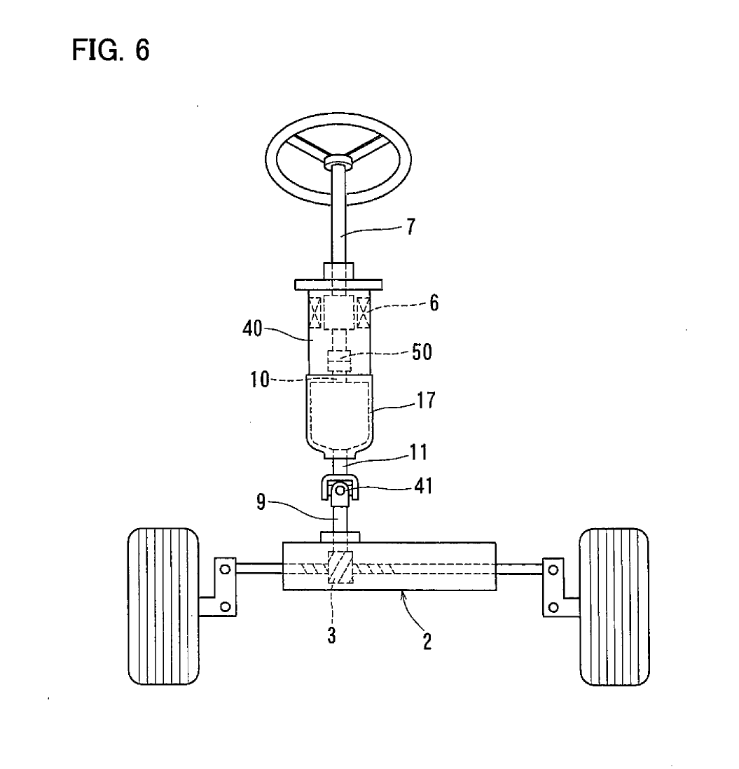

The fifth embodiment is described with reference to FIG. 6. Since the fifth embodiment is a modification of the fourth embodiment, only what differs from the fourth embodiment is described here. In the fifth embodiment, the input shaft 10 of the clutch 4 and the first shaft 7 are fixed to each other while being coaxial with each other, by a coupling means 50. The coupling means 50 is not limited provided the coupling means 50 is capable of transmitting rotation with the input shaft 10 and the first shaft 7 fixed to each other while being coaxial with each other.

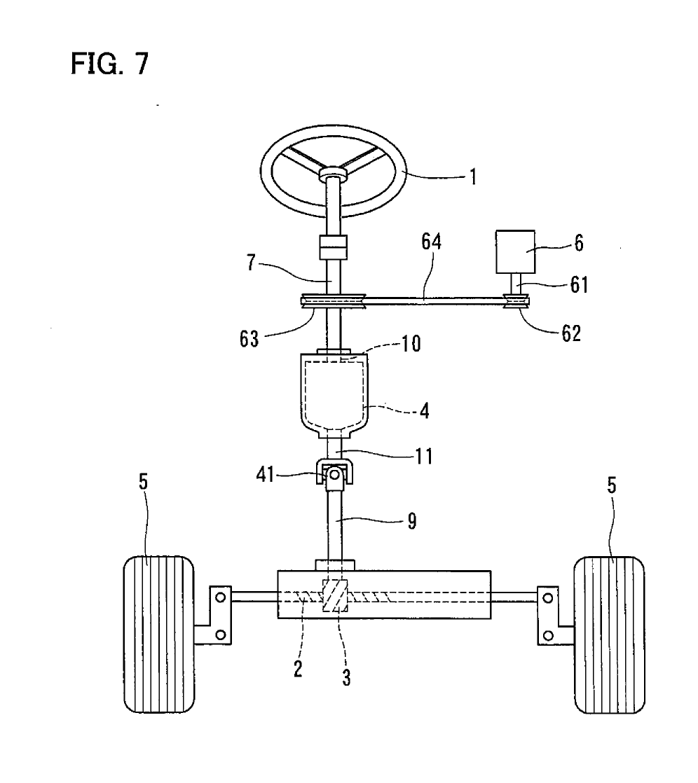

The sixth embodiment is described with reference to FIG. 7. Since the sixth embodiment is a modification of the fourth embodiment, only what differs from the fourth embodiment is described here. In the sixth embodiment, the output shaft 61 of the reaction force motor 6 and the first shaft 7 are separate members from each other. The output shaft 61 carries a driving pulley 62, while the first shaft 7 carries a driven pulley 63. A transmission belt 64 is trained around the driven pulley 63 and the driving pulley 62. A steering reaction force generated by the reaction force motor 6 is transmitted through the driving pulley 62, the transmission belt 64, and the driven pulley 63 to the first shaft 7. As means for applying a steering reaction force using a reaction force motor such as the reaction force motor 6, the one disclosed in Patent document 2 may be used.

The present invention is not limited to the above-described embodiments, and covers every modification thereof within the range defined by the claims.

### DESCRIPTION OF THE NUMERALS

1. Steering wheel
2. Rack and pinion
3. Pinion
4. Clutch
5. Steered wheel
6. Reaction force motor
7. First shaft
8. Rack
9. Second shaft
10. Input shaft of the clutch
11. Output shaft of the clutch
15, 41. Universal joint
16. Housing of the rack and pinion
17. Housing of the clutch
30. 50. Coupling means
40. Housing of the reaction force motor
61. Output shaft of the reaction force motor

1. A unit for a vehicle steering system comprising:
either a first shaft coupled to a steering wheel or a second shaft coupled to a pinion of a rack and pinion; and
a clutch mounted in a rotation transmission path between the first shaft and the second shaft,
wherein the clutch includes an input shaft and an output shaft, and either the input shaft is fixed to the first shaft while being coaxial with the first shaft, or the output shaft is fixed to the second shaft while being coaxial with the second shaft.

2. The unit for a vehicle steering system of claim 1, wherein the clutch has a housing which is integral either with a housing of a reaction force motor for generating a steering reaction force to be applied to the first shaft, or with a housing of the rack and pinion.

3. The unit for a vehicle steering system of claim 1, wherein the clutch has a housing which is a separate member either from a housing of a reaction force motor for generating a steering reaction force to be applied to the first shaft, or from a housing of the rack and pinion.

4. The unit for a vehicle steering system of claim 1, wherein the input shaft of the clutch is integral either with an output shaft of a reaction force motor for generating a steering reaction force to be applied to the first shaft, or with the first shaft.

5. The unit for a vehicle steering system of claim 1, wherein the input shaft of the clutch is a separate member either from an output shaft of a reaction force motor for generating a steering reaction force to be applied to the first shaft, or from the first shaft.

6. The unit for a vehicle steering system of claim 1, wherein the second shaft is integral with the output shaft of the clutch.

7. The unit for a vehicle steering system of claim 1, wherein the second shaft is a separate member from the output shaft of the clutch.
